(19) United States
(12) Patent Application Publication
(10) Pub. No.: US 2003/0116253 A1
(43) Pub. Date: Jun. 26, 2003

(54) Method for manufacturing a flexible curtain

(76) Inventors: Willis J. Mullet, Gulf Breeze, FL (US); Harry E. Asbury, Gulf Breeze, FL (US); Donald B. Kyle, Pace, FL (US); Kelly R. Green, Pace, FL (US); Albert W. Mitchell, Pensacola, FL (US); Mark S. Hudoba, Gulf Breeze, FL (US)

Correspondence Address: WOODLING, KROST AND RUST, 9213 Chillicothe Rd., Kirtland, OH, 44094, US

(21) Appl. No.: 10/322,965

(22) Filed: Dec. 18, 2002

Related U.S. Application Data
(63) Continuation-in-part of application No. 09/644,926, filed on Aug. 23, 2000, now Pat. No. 6,523,596.

(51) Int. Cl. B32B 31/00; B32B 31/14

(52) U.S. Cl. 156/73.1; 156/93; 156/252; 156/272.2; 156/299

(57) ABSTRACT

A method and apparatus for manufacturing a flexible curtain is disclosed and claimed. The flexible curtain is used in a windlocking apparatus to prevent the unwanted intrusion of wind, water and debris into a building opening. Strips are attached to the edges of the curtain. The strips may be attached to the curtain by first heating them followed by compressing them to form a welded or bonded construction. The heating may be accomplished by direct heat transfer, electromagnetic excitation, or ultrasonic excitation. Compressing the materials together is accomplished with rollers having cylindrical laminating surfaces to join the excited materials and form a welded or bonded construction. Alternatively, the materials may be glued or stitched together. Preferably the curtain and strips are thermoplastic materials. Semi-crystalline polymer strips may be joined to a thermoplastic curtain to add rigidity.

This is a continuation-in-part patent application of co-pending patent application Ser. No. 09/644,926, filed Aug. 23, 2000.

### FIELD OF THE INVENTION

This invention is a method and apparatus for making a flexible curtain for use as a windlocking curtain.

### BACKGROUND OF THE INVENTION

During hurricanes and other high wind velocity storms, the breach of a building opening can cause great damage to the structure. We have U.S. Pat. No. 6,296,039 B1 which addresses the use of the windlocking curtain in storm conditions. This invention discloses and claims the method and apparatus for making the windlocking curtain.

### SUMMARY OF THE INVENTION

A method for manufacturing a three-ply flexible curtain is disclosed. Two of the plys are polymeric and one is a woven substrate which resides between the two polymeric plies. A first and second laminating roll under the force of pressure and heat secures the three plys together. A plurality of beveled rollers fold the edges of the three ply construction back upon itself.

A first and second edge roller are used to laminate the folded edge to itself. The second edge roller has a notch which limits the extent of the lamination because the notched area on the second edge roller does not allow compression of the folded edge. Lack of compression of the folded edge in the notched area results in a loose flap which is useful in the application of the flexible curtain for absorbing shock during transient (storm) conditions. Alternatively, and/or additionally, the secured portion of the folded edge may be glued, stitched or welded. Perforations are made in the folded edges of the curtain. Rotary, stationary or indexing punches and dies may be used.

Alternatively, a curtain made from a single substrate may be manufactured. This curtain has two edges and each of the edges in turn has a strip affixed to it. The strips may be partially affixed to the curtain or they may be substantially entirely affixed to the curtain. The strips affixed along the edges of the curtain are necessary in the functioning as set forth in U.S. Pat. No. 6,296,039 B1. The strips may be affixed by laminating them under pressure to the curtain, gluing them to the curtain, stitching them to the curtain, or by welding them to the curtain using microwave welding devices, ultrasonic welding devices, radio frequency welding devices, heat welding devices and induction welding devices. Appropriate combinations of the preceding methods of attachment may be used if redundant securement is desired or if incompatible materials are used.

The curtain can be made from any polymeric material and, preferably, a thermoplastic material to facilitate welding. The strips which are affixed to the edges of the curtain can be made from any polymeric material and, preferably, a thermoplastic material to facilitate welding. Alternatively, the strips may be made from a semi-rigid material such as a semi-crystalline polymeric material.

It is an object of this invention to produce a flexible curtain having a folded edge which is partially secured to itself and which is partially unsecured.

It is a further object of this invention to produce a flexible curtain having a folded edge which has perforations therethrough where the edge is partially secured to itself.

It is a further object of this invention to produce a flexible curtain having a folded edge which has a loose, or free, flap capable of absorbing energy.

It is a further object of this invention to use a first edge roller and a second edge roller to partially laminate the folded edges of the flexible curtain.

It is a further object of this invention to fold the edges of a flexible curtain so that they may be partially laminated, glued, stitched or welded together.

It is a further object of this invention to laminate two plys of polymeric material to a woven substrate residing therebetween.

It is a further object of this invention to completely secure two strips of polymeric material to a polymeric substrate. Cylindrical laminating surfaces compress the entire strip and the edge of the curtain securing each to the other. The substrate itself may be a single sheet of polymeric material or it may comprise two or more polymeric sheets laminated together. Preferably the polymeric substrate is a thermoplastic material. Alternatively, and additionally, another substrate such as a woven cloth substrate or a reinforcing metal substrate may be laminated between the polymeric substrates.

It is a further object of this invention to secure thermoplastic polymeric strips to a thermoplastic polymeric substrate.

Other objects of this invention will become apparent when the drawing figures, the description of the invention and the claims are considered which follow hereinbelow.

### BRIEF DESCRIPTION OF THE DRAWINGS

FIG. 1 is a perspective view of the invention illustrating, among other things, the laminating rollers, the edge rollers, and the perforating rollers.

FIG. 1A is a perspective view similar to FIG. 1 without the stitching apparatus.

FIG. 1B is a partial cross-sectional view of the flexible curtain illustrating a folded edge.

FIG. 2 is a view illustrating much of the same structure as FIG. 1 only supports are not shown in this view.

FIG. 3 is an enlarged portion of FIG. 2.

FIG. 3A is an illustration of one edge of the curtain between the first edge roller and the second edge roller. FIG. 3A also illustrates the notch in the second roller.

FIG. 4 is another embodiment of the invention illustrating strips applied to the edges of the curtain.

FIG. 4A is another embodiment of the invention illustrating ultrasonic welding of the strip to the edge of the curtain after compression of the strip to the curtain.

FIG. 4B is another embodiment of the invention illustrating welding devices selected from the group of microwave, ultrasonic, radio frequency (RF), heat and induction welding devices. The welding devices are illustrated schematically before compression of the strips to the curtain.

FIG. 4C is an enlargement of a portion of FIG. 4B illustrating welding devices selected from the group of microwave, ultrasonic, radio frequency (RF), heat and induction welding devices.

FIG. 4D is a drawing similar to FIG. 4B with the curtain comprising a single substrate or sheet.

FIG. 5 is an enlargement of a portion of FIG. 4A.

FIG. 6 is an enlargement of a portion of FIG. 1 illustrating a rotary punch and die for perforating the folded edges of the flexible curtain.

FIG. 7 is an enlargement of a portion of FIG. 6 better illustrating the perforations in the folded edges.

FIG. 8 is an enlargement of a portion of FIG. 1 illustrating the stitching apparatus.

FIG. 9 is a flow chart of a stationary punching system.

FIG. 10 illustrates a punch and a die in cross section.

FIG. 11 illustrates the punch and die of FIG. 10 in perspective.

FIG. 12 is a perspective view of the punch and die shown together with the curtain.

A better understanding of the invention will be had when reference is made to the description of the invention and the claims which follow hereinbelow.

### DESCRIPTION OF THE INVENTION

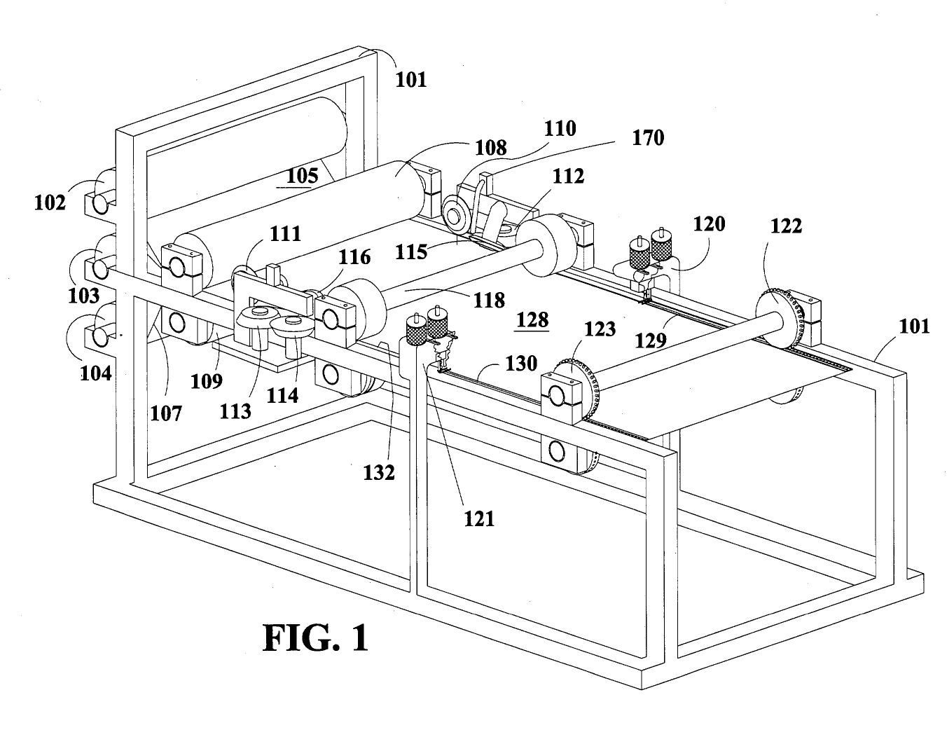

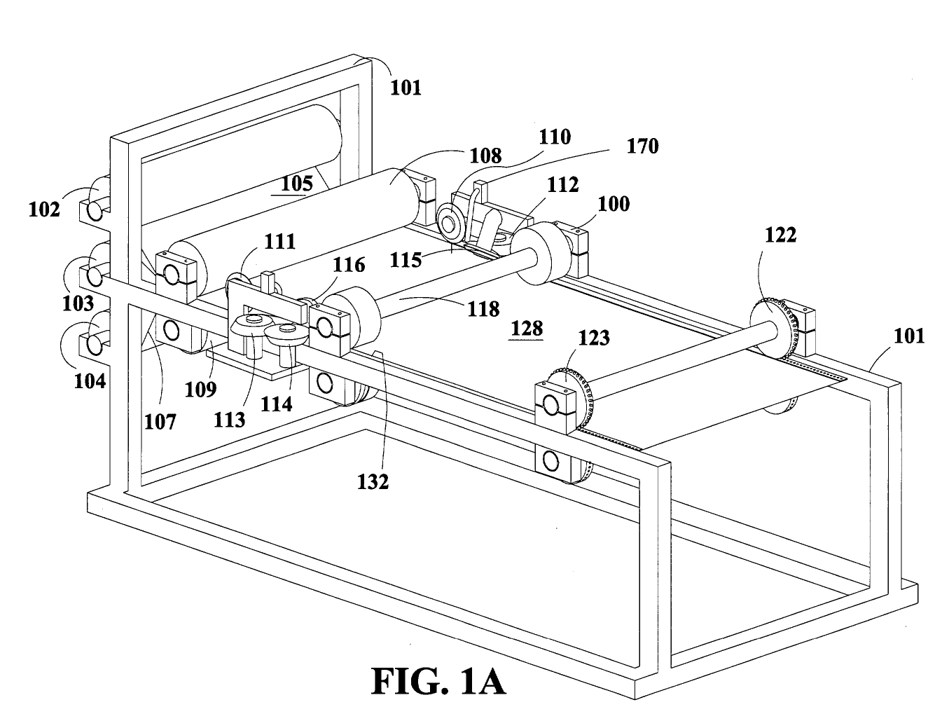

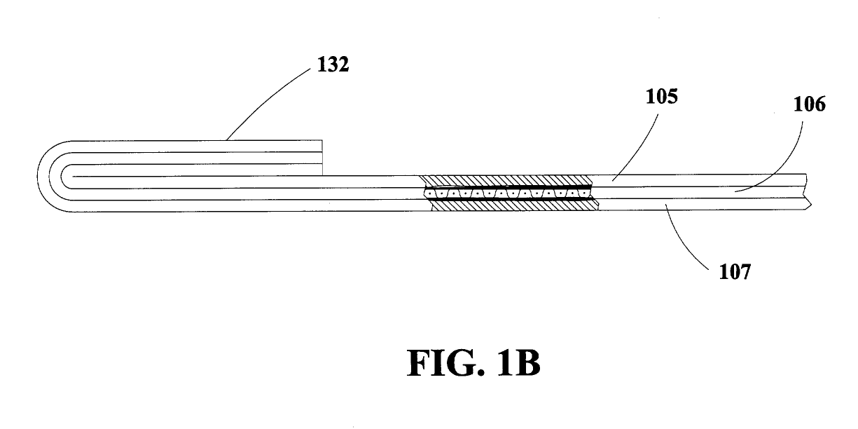

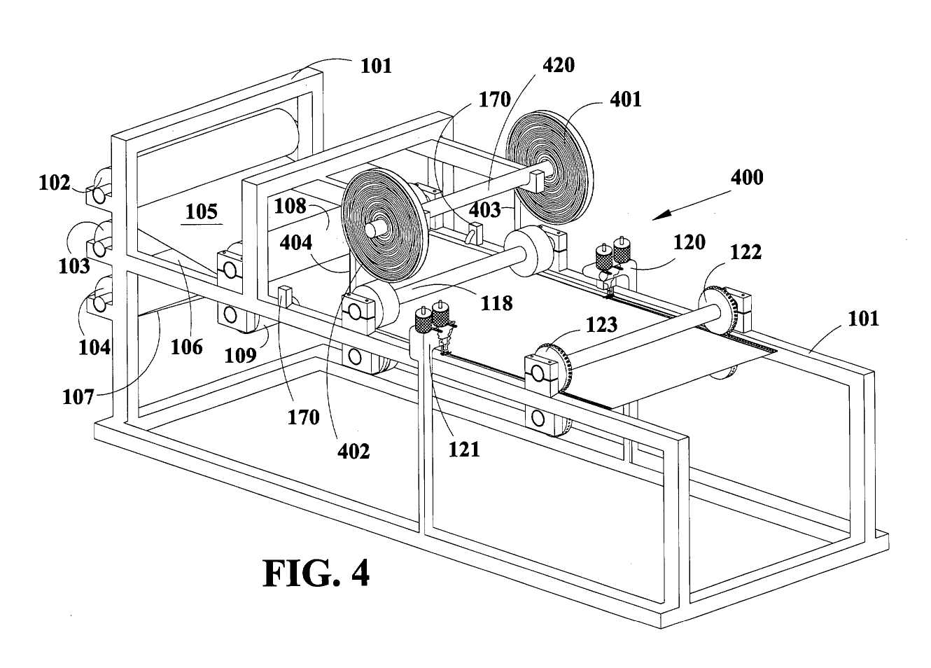

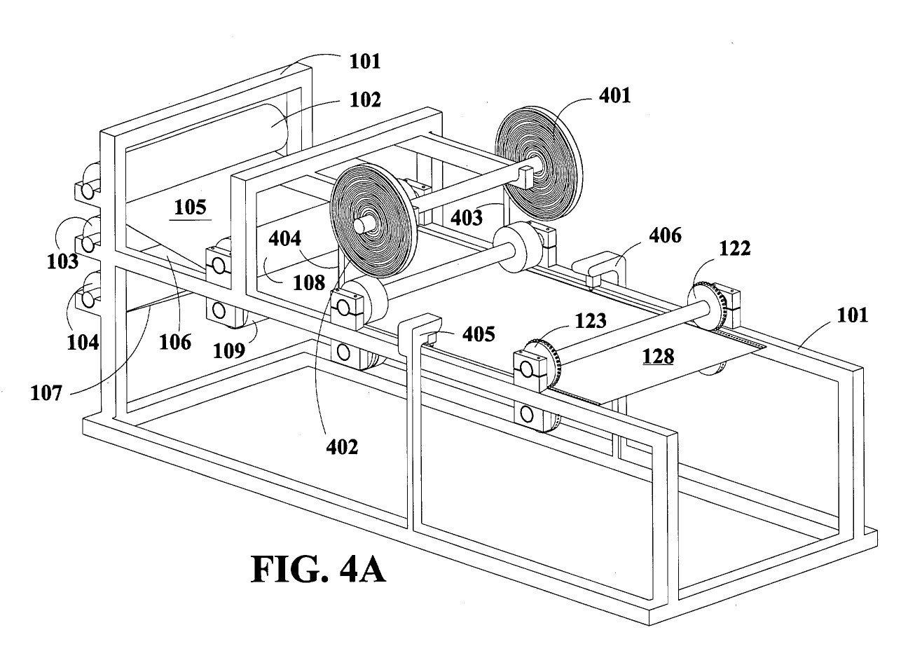

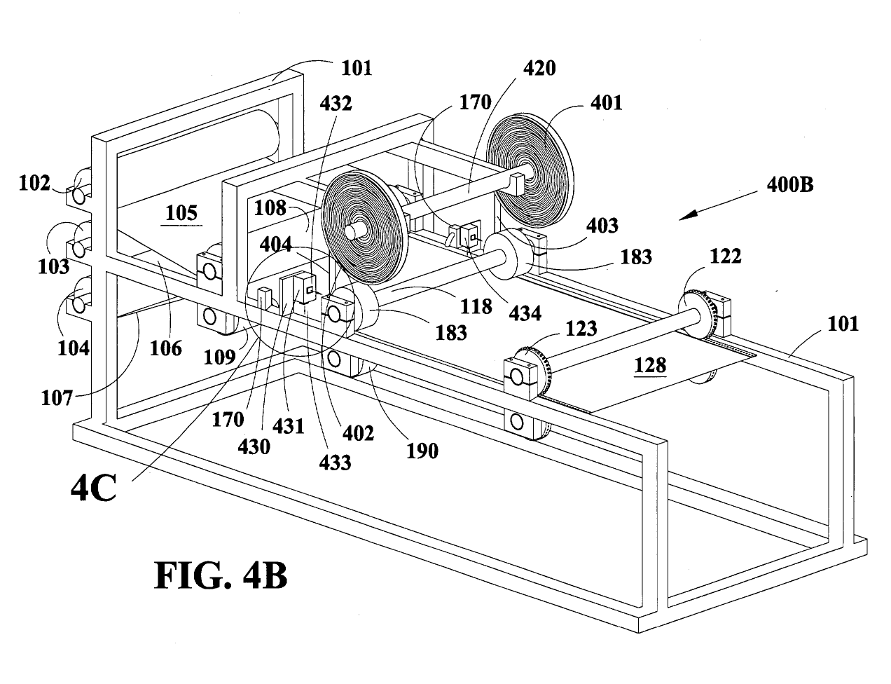

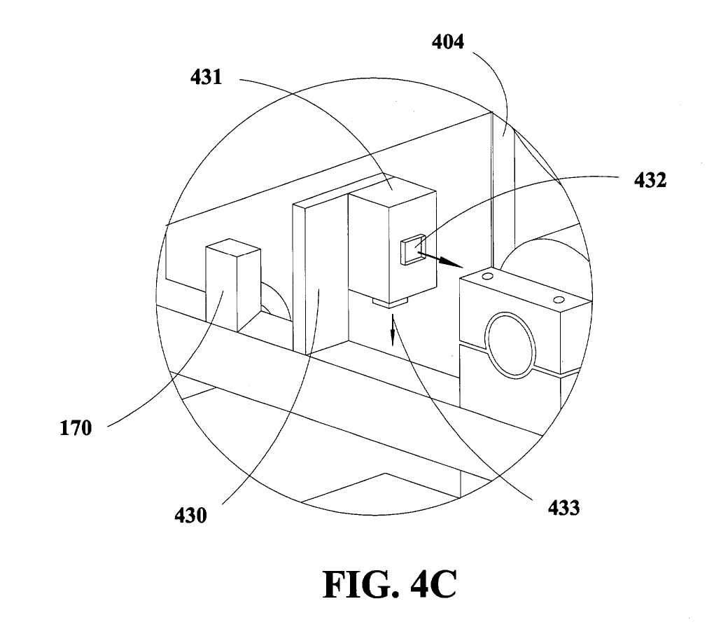

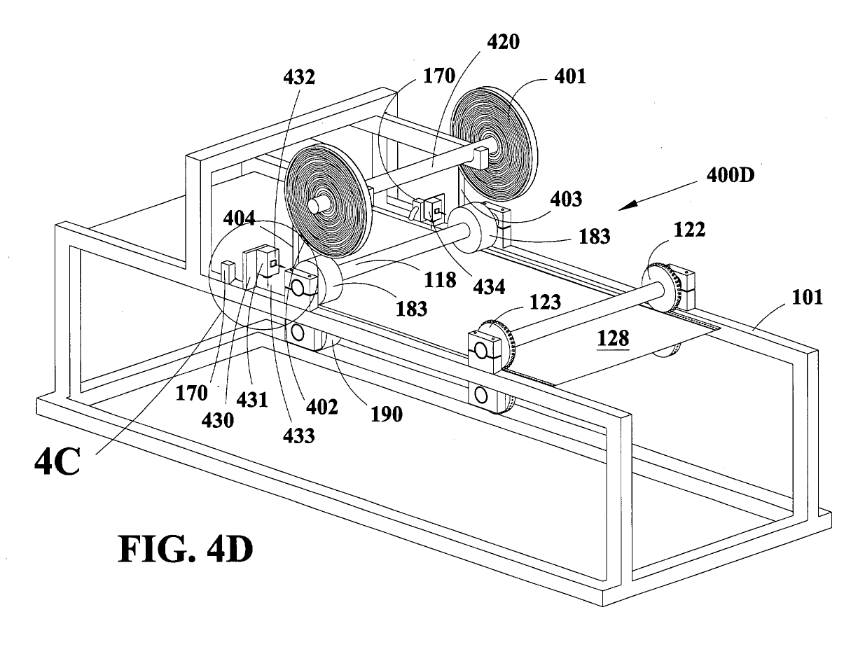

FIG. 1 is a perspective view of the invention illustrating, among other things, the laminating rollers 108, 109 the edge rollers and the perforating rollers. FIG. 1A is a perspective view similar to FIG. 1 without the stitching apparatus 120, 121. The stitching apparatus 120, 121 shown in FIG. 1 ensures that the folded edge 132 is affixed completely to the flexible curtain 128. Lamination alone of the edge 132 to the flexible curtain 128 is sufficient to attach the edge to the curtain. Stitching 120, 121, gluing 170 or welding 405, 406 (see, FIG. 4A) are additional methods of ensuring that the folded edge 132 is completely affixed to the flexible curtain.

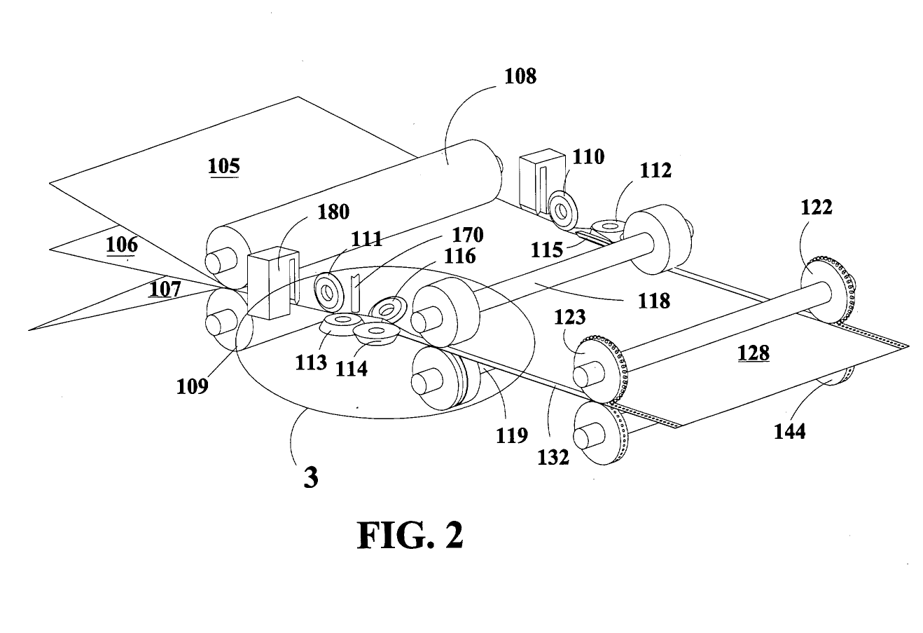

Referring to FIGS. 1 and 1A, reference numeral 101 represents the frame which positions the equipment for performing the method. First roll 102 has first polymeric material 105 wound therearound. Second roll 103 has woven sheet 106 (FIG. 2) wound therearound. Third roll 104 has second polymeric material 107 wound therearound. First and second polymeric sheets 105, 107 are laminated to the woven sheet 106 and to each other by the first laminating roll 108 and the second laminating roll 109. The three sheets 105, 106 and 107 are best viewed in FIG. 2 which is a view illustrating much of the same structure as FIG. 1 only the supporting frame 101 and structure are not shown. FIG. 2 also illustrates a slitter 180 which controls the width of the laminated curtain prior to folding of the edges.

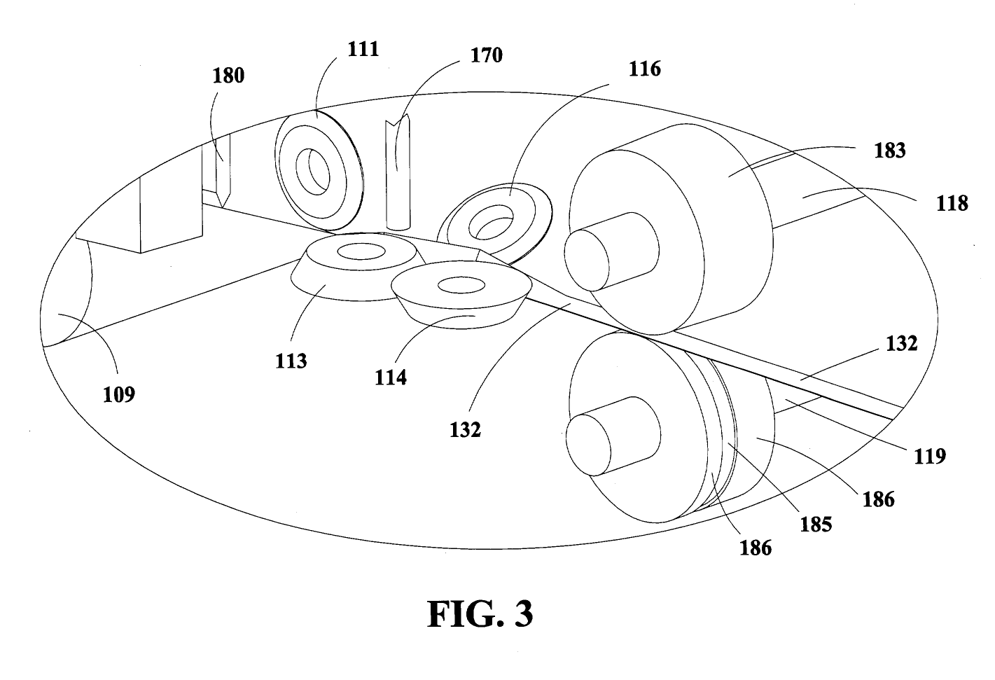

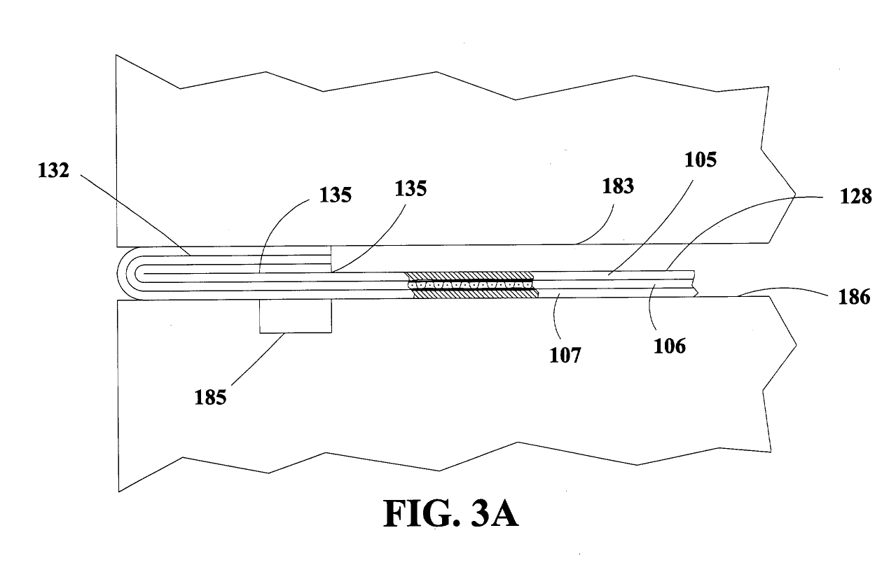

Referring to FIG. 3, which is an enlarged portion of FIG. 2, one set of beveled rollers 111 (first), 113 (second), 114 (third) and 116 (fourth) are illustrated. The other set of beveled rollers 110, 112, 115 are also viewed in FIGS. 1, 1A and 2. There are four beveled rollers on the far side but only three are visible in these perspective views.

Referring to FIGS. 2 and 3, first beveled roller 111 and second beveled roller 113 begin to turn the edge of the flexible curtain 128 vertically upward. Third beveled roller 116 in combination with second beveled roller 113 begin to fold the flexible curtain inwardly on itself Fourth beveled roller 114 completes the fold. Although the flexible curtain is folded leaving fourth beveled roller 114, it is not laminated upon itself at this point. FIG. 1B is an illustration of the curtain and an edge 132 folded upon itself but not laminated.

Folded edge 132 next passes through first edge roller 118 and second edge roller 119. Referring to FIGS. 3 and 3A, first edge roller 118 includes an enlarged end portion 183 which is cylindrically shaped and has a constant diameter. Second edge roller 119 includes an enlarged end portion 186 which is cylindrically shaped and has a circumferential notch 185 therein. Circumferential notch 185 is a circumferential notch in cylindrical end portion 186 of edge roller 119. As folded edge 132 passes through end portions 183 and 186 of edge rollers 118, 119 it is compressed and laminated except for the portion proximal (i.e., near) to notch 185. The function of the circumferential notch 185 is to prevent lamination of the folded edge portion 132 of the flexible curtain proximal (i.e. near) the notch. Reference numeral 135 indicates the extent of the folded edge 132 which is not laminated. See, FIG. 3A.

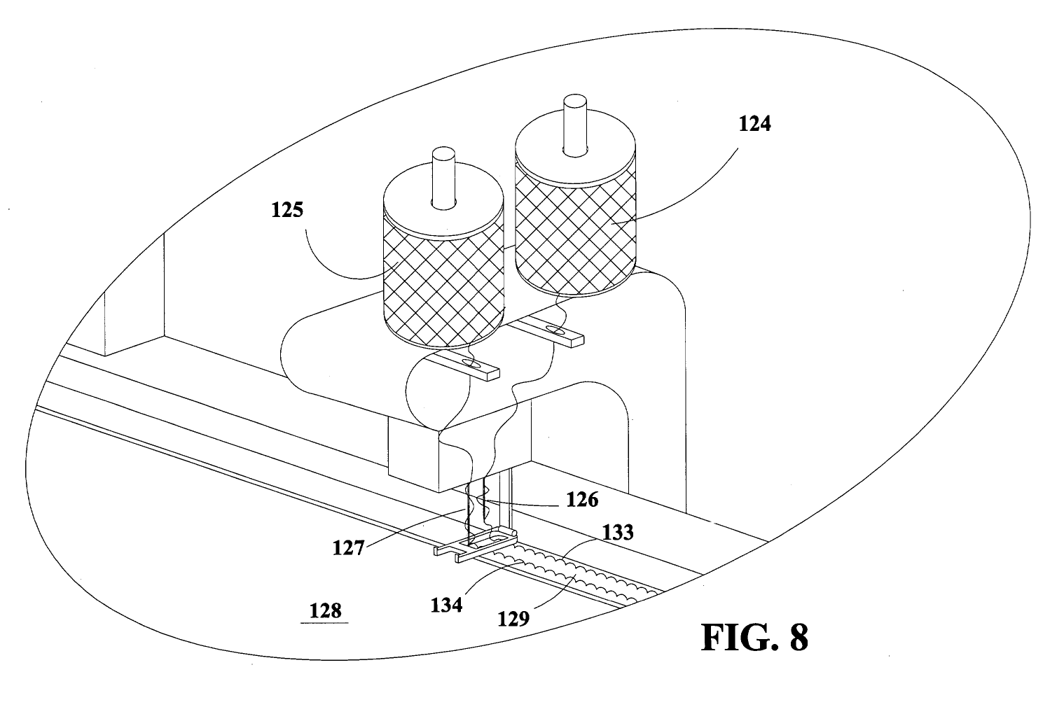

FIG. 1A represents an embodiment of the invention. Stitching apparatus 120, 121 may be employed to reinforce the attachment of the folded edge 132 to the flexible curtain 128. A stitching apparatus 120 can be seen in more detail by referring to FIG. 8, an enlargement of a portion of FIG. 1. FIG. 8 illustrates thread 124, 125 needles 126, 127, and stitching 133, 134. Another method of reinforcing the bond between the folded edge 132 and the flexible curtain 128 is to apply adhesive with an applicator 170 prior to completion of the folding of the edge as best seen in FIGS. 1, 2 and 3. Still referring to FIG. 8, reference numeral 129 indicates the area of the folded edge secured by the stitching. Referring to FIG. 1, stitching is indicated by reference numerals 129 and 130. Stitching may be used in addition to lamination. When the flexible curtain produced by this invention is used to protect building openings, great force will be exerted on the portion of the folded edge secured to itself. Redundant securement of the folded edge can also be effected by ultrasonic welding 405, 406 (FIG. 4A), heat welding or electromagnetic welding (FIG. 4B).

FIG. 4 is another embodiment 400 of the invention illustrating polymeric strips 403, 404 applied to the edges of the curtain. Polymeric strips 403, 404 are coiled up in coils 401, 402 on a spindle 420 and are dispensed therefrom and laminated by edge rollers 118, 119. Additionally, the strips may be stitched with stitching apparatus 120, 121 (FIG. 4) or ultrasonically welded 405, 406 (FIG. 4A). FIG. 4A is another embodiment of the invention 400A illustrating ultrasonic welding of the strips 403, 404 to the edge of the curtain 128 after compression of the strips to the curtain. FIG. 4A illustrates ultrasonic welding after lamination of the strips to the curtain. FIG. 5 is an enlargement of a portion of FIGS. 4 and 4A and better illustrates the lamination of the strips 403, 404 to the three ply flexible curtain 128.

Welding of polymeric material involves the heating of the materials to be joined followed by the application of pressure to the material to be joined. Depending on the type of heating source used in the welding process, the application of pressure is simultaneous or nearly simultaneous with the application of heat to the material to be joined. The variables of heating, pressure and time are to a certain extent dictated by the materials to be joined.

FIG. 4B is a view similar to FIG. 4A with welding devices 431 and 434 shown schematically. Bracket 430 is illustrated supporting welding device 431. Arrows 432 and 433 schematically indicate heating of the curtain and the strips 402 and 403 by any of the methods, namely, heating, induction, microwave, radio frequency or ultrasonic. Additionally, the strips 403, 404 are completely affixed to the curtain 128 as illustrated in FIG. 4B. This embodiment differs from the embodiment of FIGS. 4 and 4A wherein only portions of each of the strips 403 and 404 are affixed to the curtain leaving flaps or remainders unsecured to the edges. The embodiment of FIGS. 4 and 4A require notch 185 in roller 186.

In the embodiment of FIG. 4B, compressing or laminating surfaces 183 and 190 of rollers 118 and 119 compress the entirety of the polymeric strips to the curtain 128 shortly after the strips and curtain have been heated. Heating takes place as a result of subject the material to be heated to hot air, sonic energy or electromagnetic energy (radio frequency energy, electrical induction energy or microwave energy). Neither roller 183 nor roller 190 has a notch therein. The curtain may be a three-ply curtain 128 as is illustrated in FIG. 4B or it may be a single ply curtain 128 as indicated in FIG. 4D.

The type of weld used will be determined by the type of curtain and strips used. Heat welding may be performed using various types of vinyl films, vinyl laminated fabrics, vinyl coated fabrics, propylene, polyethylene and urethane films. Thermoplastic materials have a linear macro-molecular structure that will repeatedly soften when heated and harden when cooled. Essentially, thermoplastic means becoming plastic on being heated and includes any resin which can be melted by heat and then cooled repeatedly any number of times without appreciable change in properties. Examples of thermoplastic materials are styrene, acrylics, cellulosics, polyethylenes, vinyls, nylons, and fluorocarbons. Semicrystalline plastics such as polypropylene have some thermoplastic properties but required different techniques and energy levels in the welding process.

The welding devices illustrated in FIGS. 4B, 4C, and 4D are well known for use in other arts and are shown schematically here. These welding/heating devices could also be oriented downstream of the compression rollers 183, 190 as illustrated in FIG. 4A but usually welding occurs nearly simultaneously with the application of pressure. These welding devices can be selected from the group of microwave, ultrasonic, radio frequency (RF), heat and induction.

Devices 431 and 434 of FIG. 4B may be hot air or heat devices. Reference numerals 432 and 433 indicate arrows which in turn indicate the application of hot air to the surfaces to be joined. Heat welding, also known as rotary heat sealing, is performed by injecting hot air between two layers (128, 403,404) of thermoplastic material and preparing the two surfaces for molecular bond. The temperature used in combination with the amount of air used determines the amount of energy transferred to the thermoplastic material to be welded together. Pressure and speed are controlled by the laminating surfaces 183 and 190. The rate of rotation of the rollers is the speed at which the material is bonded together and the pressure applied is determined by the spacing between the laminating surfaces 183 and 190. Heat welding provides a very good bond of thermoplastic materials.

Devices 431 and 434, shown schematically in FIG. 4B, may be radio frequency devices. Radio frequency welding (RF welding) is also known as dielectric welding. Radio frequency welding is the process of fusing material together by applying radio frequency energy to the material. Radio frequency welding is used to join or assemble various thermoplastic materials such as PVC (polyvinylchloride) and polyurethanes. Unlike a straight heat weld, the material is only heated while RF energy is being generated.

Radio frequency welding, or dielectric welding, uses a high frequency radio signal acting upon a polar polymer. Thermoplastic polymers are placed between electrodes which are excited by a radio frequency generator. Each of the electrodes is alternately positively and negatively charged with the frequency being switched at the rate of the generator. The thermoplastic polymers heat up from the friction between the molecules of the polymers as they are subjected to the alternating electromagnetic field. See, www.ferris.edu/cot/accounts/plastics/htdocs/Prey as published by Ferris State University, and as authored by Matt Prey, which is incorporated herein by reference.

RF Welds are usually as strong as the original material prior to welding. Materials that are commonly RF welded include polyvinylchloride (PVC), ethylene vinyl acetate, polyurethanes, polyethylene terephtalate and polyamide. Some thermoplastics such as polyethylene and polypropylene cannot be welded using RF energy. The speed and pressure of the laminating surfaces 183 and 190 will be dictated by the material used and the amount of radio frequency energy inputted into the flexible curtain 128 and the polymeric strip 403, 404.

Usually, RF energy is directed toward the materials to be joined while they are in direct contact with each other. Referring to FIG. 4B, a certain liberty has been taken with respect to the depiction of RF sources 431 and 434 in that they indicate application of radio frequency energy into the curtain and the polymeric strip 403, 404 while the two are separated and just before they join under the influence of laminating surfaces 183 and 190. Further, it will be understood by those skilled in the art that the illustration of the radio frequency sources is a schematic and that radio frequency welding equipment well known in the art can be spatially adapted to the process illustrated in FIG. 4B. Also see, http://www.ewi.org/technologies/plastics/dielectric.asp which is incorporated herein by reference.

Devices 431 and 434, shown schematically in FIG. 4B, may be ultrasonic welding devices. Ultrasonic welding of plastics is a technology which has been practiced for several years. Vibrations are introduced vertically and frictional heat is produced so that the material plasticizes and connects very quickly. The materials to be joined must have similar melting points.

A metal tool (horn) oscillates vertically and transforms electrical energy into sound energy. The frequency of oscillations usually varies between 20 to 40 kHz but the frequency may be outside that range. Oscillation amplitudes range from 20 to 80 microns.

Ultrasonic welding is used to join amorphous (i.e., non crystalline) thermoplastics. However, semicrystalline polymers are welded routinely now using high power machines. Many variables are microprocessor controlled during ultrasonic welding. See, www.ewi.org/technologies/plastics/ultrasonic.asp which is incorporated herein by reference.

Devices 431 and 434, shown schematically in FIG. 4B, may be microwave devices. Microwave welding is similar to radio frequency welding, except that it uses a much higher frequency from 70 MHz to 100 GHz. A composite gasket is used which is a combination of a thermoplastic parent material and a conductive material, known as an electromagnetic susceptor. Polyaniline, or PANI is an organic metal which may be used as the conductive material in the gasket. Polyaniline is sometimes referred to as a polyaniline salt. See, www.ferris.edu/cot/accounts/plastics/htdocs/Prey as published by Ferris State University, and as authored by Matt Prey which is incorporated herein by reference. Polyaniline is sometimes referred to as a polyaniline salt.

Polymers that conduct electric currents without the addition of conductive (inorganic) substances are known as intrinsically conductive polymers are these materials conduct electric currents without the addition of inorganic substances (i.e., metals).

Polyaniline (PANI) has achieved wide spread commercial availability. See, www.zipperling.de which is incorporated herein by reference in regard to polyaniline. Polyaniline is produced by Zipperling Kessler & Co. located in Ahrensburg, Germany.

The electromagnetic susceptor in the gasket absorbs the microwave energy and heats up. Thermoplastic substances that are to be welded together heat up as heat generated from the gasket is transferred to the thermoplastic material creating a molten layer which allows the molecules to inter-diffuse. The susceptor is placed between the substrates and as the susceptor is heated, that heat is transferred to the substrates forming a molten layer on each of the substrates. Pressure is then applied to the substrates which extracts the susceptor and welds the thermoplastic substrates together. Referring to FIG. 4B, a susceptor is placed between the strips 403, 404 and the curtain 128.

Devices 431 and 434, shown schematically in FIG. 4B, may be induction heating devices. Induction welding magnetically excites a ferromagnetic material located within the thermoplastic material to be joined. The ferromagnetic material heats up because it is magnetically coupled to the exciter coil and the heat is transferred to the thermoplastic material around it. Inductive heating works on the same general principle as a transformer or electric motor. An external force or pressure is then applied, for instance, by laminating surfaces 183, 190 forcing the molten material to flow and weld the thermoplastic materials. See, http://www.ewi.org/technologies/plastics/induction.asp which is incorporated herein by reference. Thermoplastics are readily weldable by the induction welding process.

FIG. 4C is an enlargement of a portion of FIG. 4B illustrating welding devices selected from the group of microwave, ultrasonic, radio frequency (RF), heat and induction welding devices. FIG. 4C illustrates the arrows 432 and 433 which schematically depict the heating of the curtain and the strip 404 by different heating devices.

FIG. 4D is a drawing similar to FIG. 4B with the curtain comprising a single substrate or sheet 128.

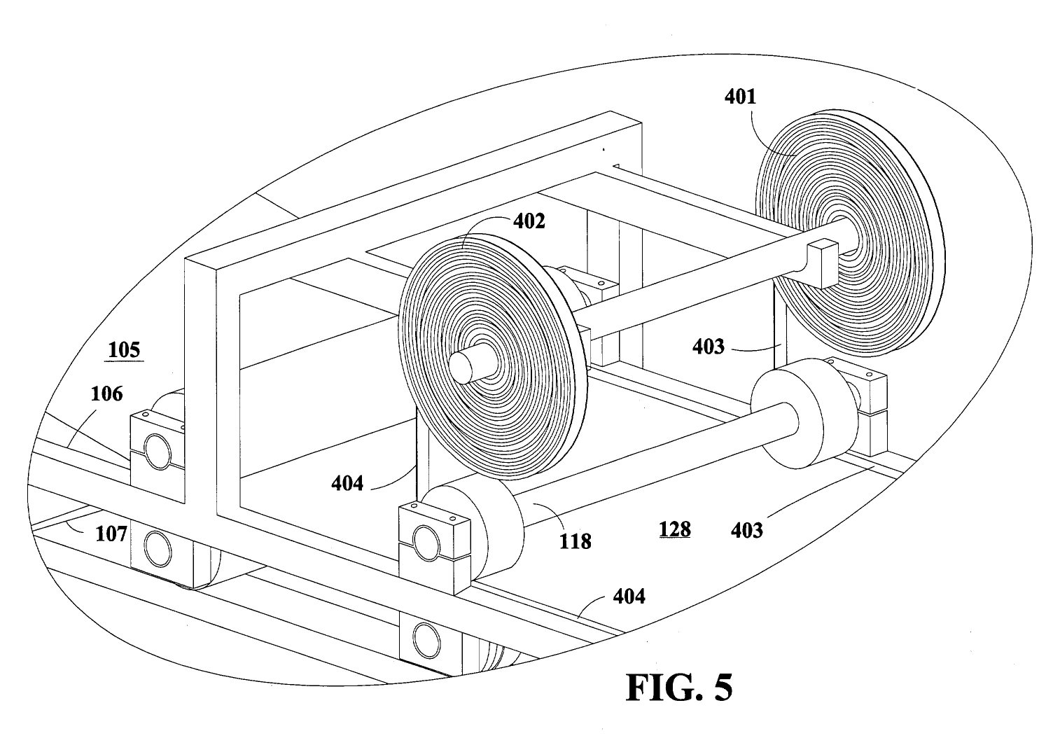

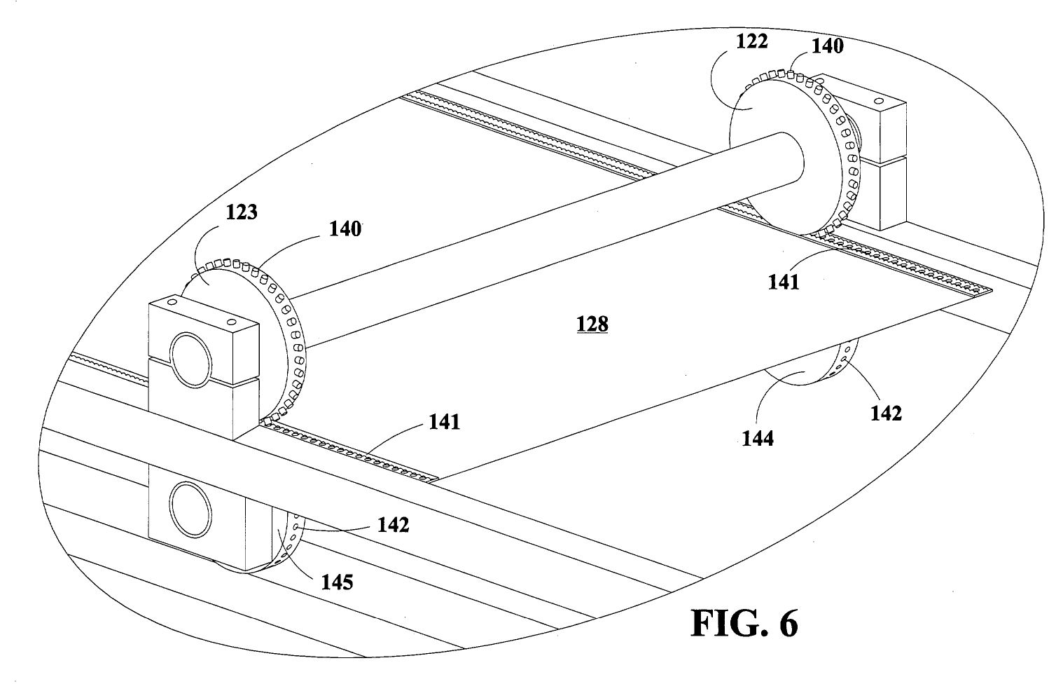

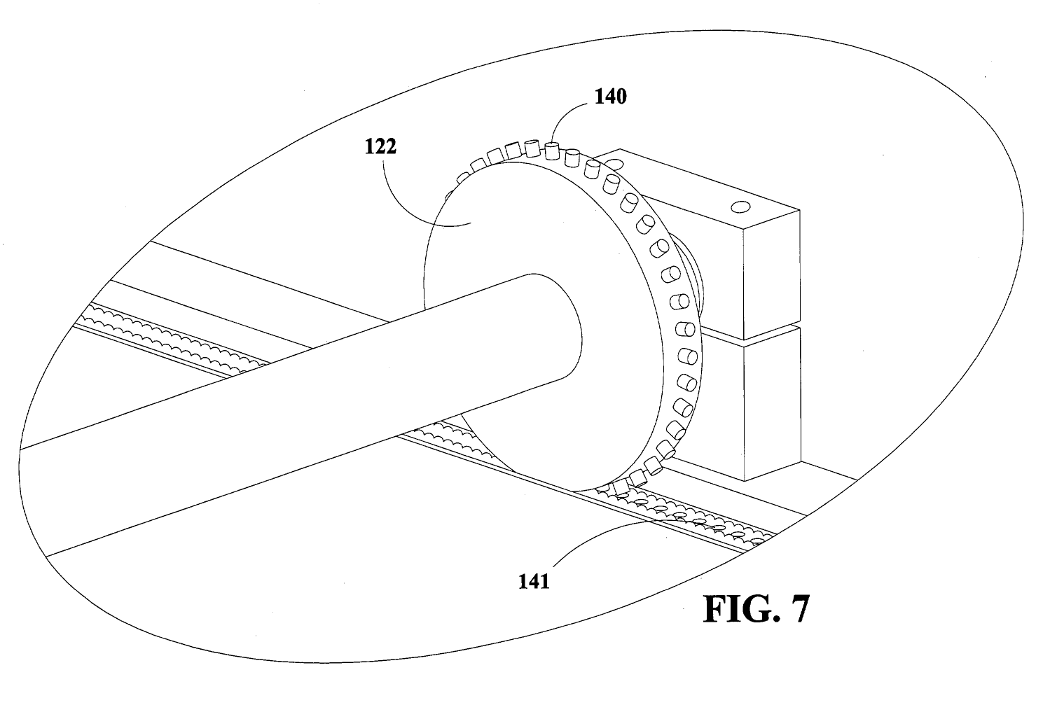

FIG. 6 is an enlargement of a portion of FIG. 1 and illustrates the first perforating rollers 122, 123 with protrusions 140 therein. The rotary punch and die are usable on the curtains having folded edges and they are useful on the curtains which have a polymeric strip secured thereto as set forth in FIGS. 4, 4A, 4B, 4C and 4D. Sometimes herein the perforating rollers 122, 123 are referred to as rotary punches. Reciprocating rollers 144, 145 have apertures or dies 142 therein which receive the protrusions 140 together with the polymeric material which has been punched out. Protrusions 140 and dies 142 are preferably cylindrical but other shapes may be used. By punched out it is meant perforated as indicated by the perforations 141 in FIG. 7. FIG. 7 is an enlargement of a portion of FIG. 6. The punched out material exits the die through passageways (not shown in the drawings). The rotary dies can be driven by a motor if desired.

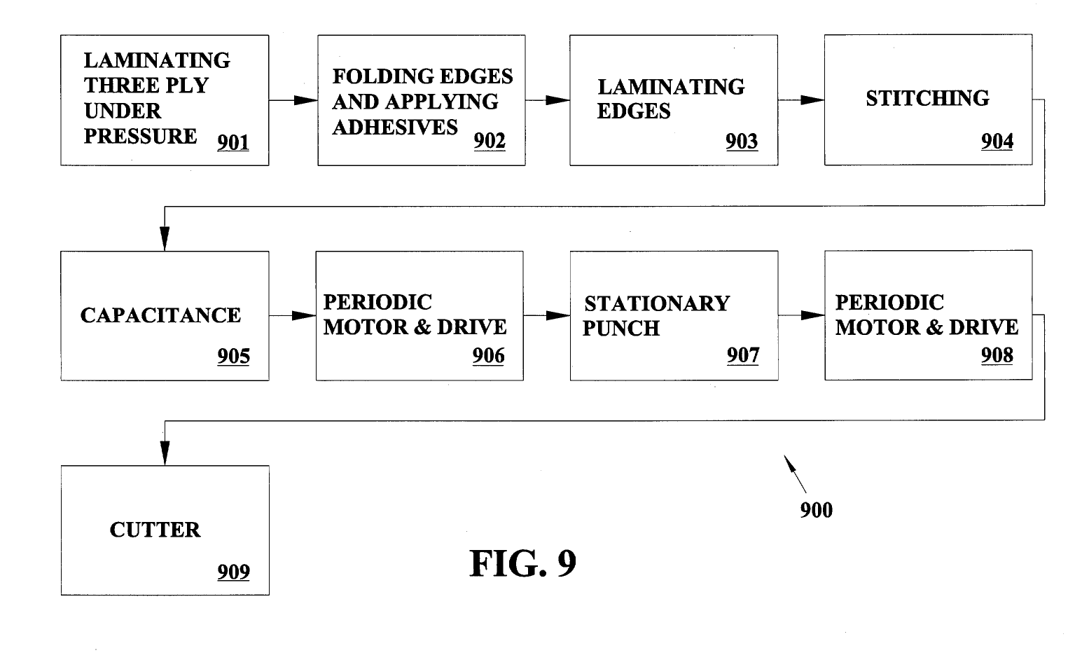

Alternatively, the flexible curtain may be driven by a motor 906 and may include a capacitance station 905 if stationary punching is desired. See, FIG. 9, an embodiment of the invention set out in diagrammatic form and represented generally by the reference numeral 900. This embodiment discloses a drive system and a stationary punch. A three ply polymeric flexible curtain is laminated initially in the first step 901. Edges are folded and adhesive is applied in the next step 902. Those edges are laminated 903 and additionally may be stitched 904. A capacitance station 905, sometimes referred to herein as a surge station, may be used if a stationary punch is employed. A first periodic motor and drive 906 feeds the stationary punch 907. A second periodic motor and drive 908 is synchronized to the first periodic motor and drive 906 and feeds a cutter 909 which cuts the flexible curtain into usable lengths.

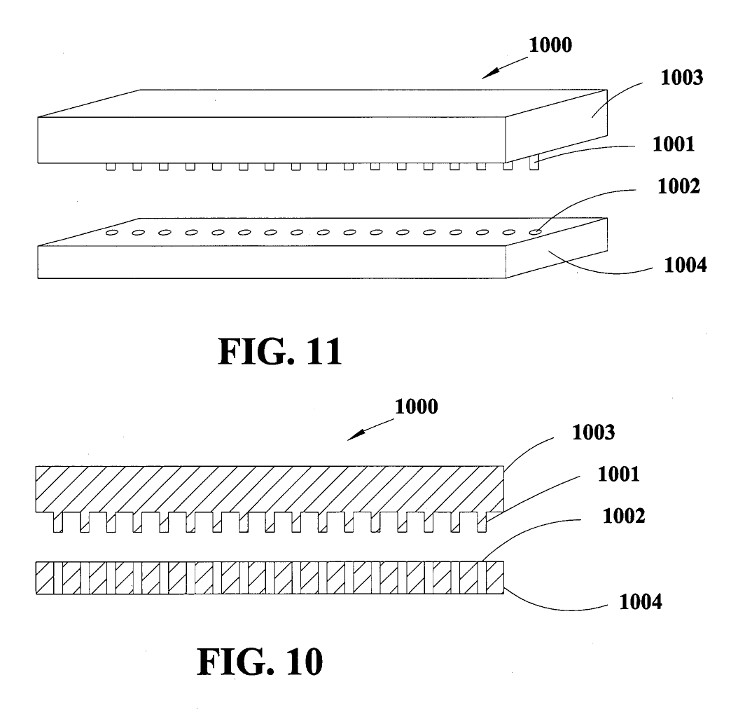

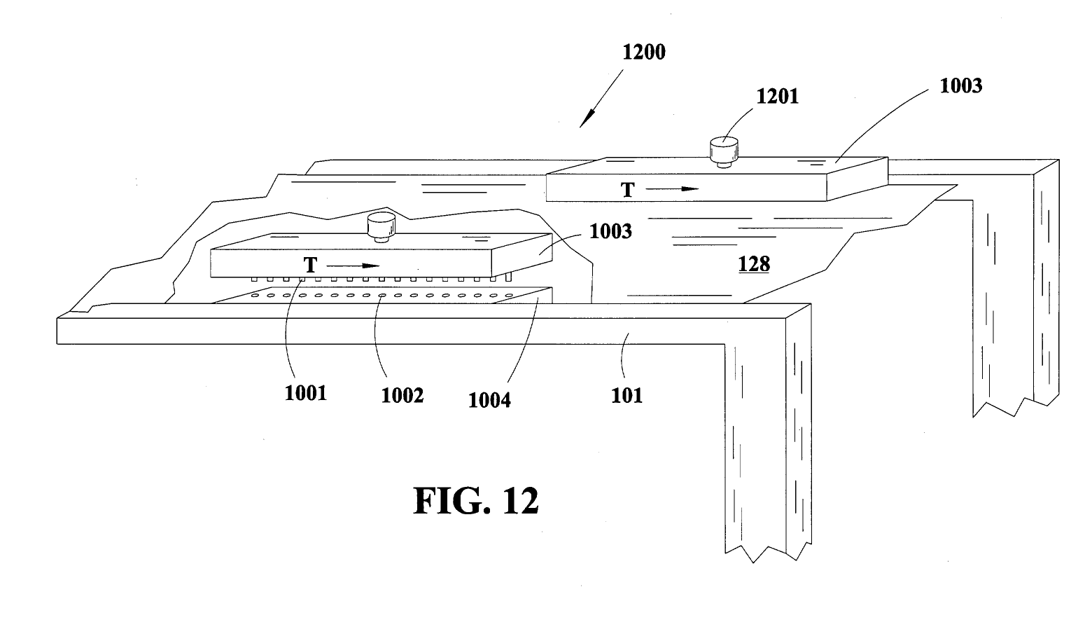

The stationary punch 1000 is illustrated in FIGS. 10 and 11. FIG. 10 is a cross sectional view illustrating the die 1004 and the punch 1003 having projections 1001. Apertures 1002 accept the projections 1001 and may be of varied sizes and shapes. Punched out material exits the die 1004 at the bottom of the apertures 1002.

Reference numeral 1200 illustrates the punches 1003 and the dies 1004 in position. The punches and dies may be indexed as indicated by the letter T which stands for translational movement of the dies at the same speed of the curtain. Operator 1201 represents diagrammatically the structure necessary to drive the punch 1003 into the die 1004.

It will be apparent to those skilled in the art that several changes may be made to the invention as disclosed herein without departing from the spirit and the scope of the appended claims.

We claim:

1. A method for manufacturing a flexible curtain having strips affixed to the edges thereof, comprising the steps of:
heating said strips and edges of said curtain;
applying pressure to said strips and said curtain; and, bonding said strips and said curtain together.

2. A method for manufacturing a flexible curtain as claimed in claim 1 wherein said step of heating said strips and edges of said curtain is performed by blowing hot air onto and over said strips and said curtain.

3. A method for manufacturing a flexible curtain as claimed in claim 1 wherein said step of heating said strips and said edges of said curtain is performed by electromagnetically exciting said strips and said edges of said curtain.

4. A method for manufacturing a flexible curtain as claimed in claim 1 wherein said step of heating said strips and said edges of said curtain is performed by ultrasonically exciting said strips and said edges of said curtain.

5. A method for manufacturing a flexible curtain as claimed in claim 1 wherein said step of heating said strips and said edges of said curtain is performed by microwave excitation of said strips and said edges of said curtain.

6. A method for manufacturing a flexible curtain as claimed in claim 1 wherein said step of heating said strips and said edges of said curtain is performed by inducing a current in a coil contacting said strips and said edges of said curtain.

7. A method for manufacturing a flexible curtain as claimed in claim 1 wherein said curtain is a thermoplastic material and said strips are a thermoplastic material.

8. A method for manufacturing a flexible curtain as claimed in claim 1 wherein said curtain is a thermoplastic material and said strips are a semi-rigid material.

9. A method for manufacturing a flexible curtain as claimed in claim 1 wherein said curtain is a thermoplastic material and said strips are a semi-crystalline polymer.

10. A method for manufacturing a flexible curtain as claimed in claim 1 wherein said curtain is a single thermoplastic sheet.

11. A method for manufacturing a flexible curtain as claimed in claim 1 wherein said curtain comprises at least two thermoplastic sheets.

12. A method for manufacturing a flexible curtain as claimed in claim 1 wherein said step of applying pressure to said strips and said curtain is performed with laminating rollers which apply pressure to said curtain and said strips fusing each to the other.

13. A method for manufacturing a flexible curtain as claimed in claim 1 wherein said strips are stored in and dispensed from coils.

14. A method for manufacturing a flexible curtain as claimed in claim 1 wherein said step of applying pressure to said strips and said curtain is performed after said step of heating said curtain and said strips.

15. A method for manufacturing a flexible curtain as claimed in claim 1 wherein said step of applying pressure to said strips and said curtain is performed before said step of heating said curtain.

16. A method for manufacturing a flexible curtain as claimed in claim 1 further comprising the step of:
creating apertures punched by a rotary punch.

17. A method for manufacturing a flexible curtain as claimed in claim 1 further comprising the step of:
creating apertures punched by a stationary punch.

18. A method for manufacturing a flexible curtain as claimed in claim 1 further comprising the step of:
creating apertures punched by an indexing punch.

19. A method for manufacturing a flexible curtain as claimed in claim 1 further comprising the step of:
gluing said strips to said edges of said curtain.

20. A method for manufacturing a flexible curtain as claimed in claim 1 further comprising the step of:
stitching said strips to said edges of said curtain.

21. A method for manufacturing a flexible curtain having strips partially affixed to the edges thereof, comprising the steps of:
laminating a portion of said strips along the edges of said flexible curtain.

22. A method for manufacturing a flexible curtain as claimed in claim 21 further comprising the steps of:
welding a portion of said strips along said edges of said curtain.

23. A method for manufacturing a flexible curtain as claimed in claim 22 wherein said welding is performed by hot air welding.

24. A method for manufacturing a flexible curtain as claimed in claim 22 wherein said welding is performed by electromagnetic welding.

25. A method for manufacturing a flexible curtain as claimed in claim 24 wherein said welding is performed by ultrasonic welding.
